(19) United States
(12) Patent Application Publication
(10) Pub. No.: US 2020/0324939 A1
(43) Pub. Date: Oct. 15, 2020

(54) Envelope with Detachable Component

(71) Applicant: WILopEN Products, LC, Deerfield Beach, FL (US)

(72) Inventors: Corey Wilen, Plainview, NY (US); Gordon M. Kramer, Coral Springs, FL (US)

(73) Assignee: WILopEN Products, LC, Deerfield Beach, FL (US)

(21) Appl. No.: 16/842,384

(22) Filed: Apr. 7, 2020

Related U.S. Application Data
(60) Provisional application No. 62/832,640, filed on Apr. 11, 2019.

(51) Int. Cl. B65D 27/34; B42D 15/08

(52) U.S. Cl. CPC B65D 27/34; G06Q 30/0207; B42D 15/08

(57) ABSTRACT

An envelope that includes an envelope portion and a detachable component that is separable from the envelope at a line of perforation is described. The detachable component can include printed matter, for example, an offer for goods or services, a discount code, or a coupon.

### CROSS-REFERENCE TO RELATED APPLICATIONS

This application is a nonprovisional application of and claims priority from U.S. provisional patent application Ser. No. 62/832,640, filed on Apr. 11, 2019. The foregoing application is incorporated in its entirety herein by reference.

### FIELD OF THE INVENTION

The invention relates to advertising and delivery methods. More particularly, the invention relates to an envelope having a detachable component at one end that is separable from the envelope at a line of perforation.

### BACKGROUND

Advertisers often send advertisements via mail service enclosed in envelopes. Many recipients, i.e., potential customers who are the targets of the advertising, disregard and discard such letter advertisements without opening their envelopes to view the advertisement and information enclosed inside the envelope.

A need exists for apparatuses and methods for delivering advertisements that entice recipients to open the envelope and to view the advertisement or other information contained on a printed item enclosed inside the envelope.

### SUMMARY

The invention relates to an envelope that includes an envelope portion and a detachable component that is separable from the envelope at a line of perforation is described. The detachable component can include printed matter, for example, an offer for goods or services, a discount code, or a coupon. The envelope includes a pocket and, optionally, a lid. The pocket of the envelope can be divided by adhesive applied to one or more inner surfaces of the envelope so that the envelope portion and the detachable component each have their own separate pockets. The line of perforation can be present on both the front and rear faces of the envelope as well as on its lid so that the envelope portion and detachable component each have their own separate lids. When the detachable component is separated from the envelope portion, an item may be placed into the pocket of the detachable component, or in other embodiments, an item (e.g., a gift card or other payment card or coupon) may already be present inside the pocket of the detachable component when the envelope is received by a recipient from a sender.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a front view of an envelope having a detachable component at one end that is separable from the envelope at a line of perforation.

FIG. 2 is a rear view of the envelope and detachable component of FIG. 1.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

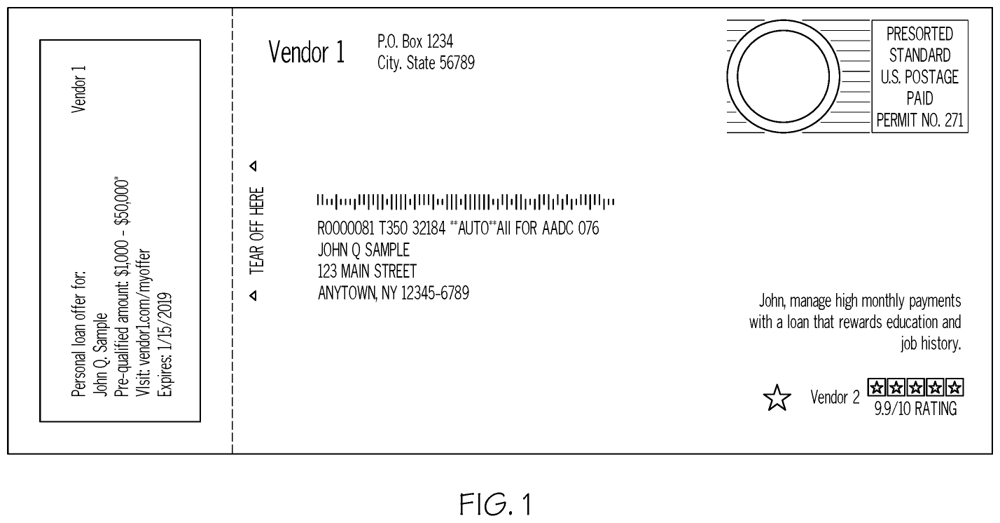

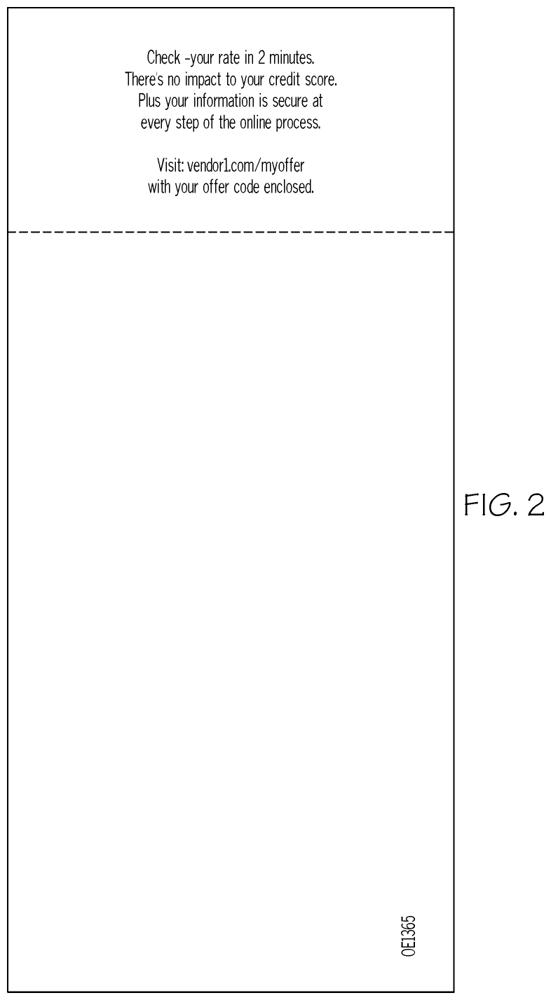

As shown in FIGS. 1 and 2, the invention provides an envelope having an envelope portion and a detachable component that is separable from the envelope at a line of perforation. The envelope includes an open top side and closed left, right, and bottom sides. The envelope portion may be formed by the left side or end of the envelope while the detachable component is formed by the right side or end of the envelope, or in other embodiments, the envelope portion may be formed by the right side or end of the envelope while the detachable component is formed by the left side or end of the envelope. The detachable component includes printed matter, which can be an offer for goods or services, a discount code, or a coupon. The printed offer may also include advertising, information, images, photographs, alphanumeric text, or a combination of two or more of the foregoing.

The envelope portion includes a pocket within which an item (e.g., a sheet of paper or other material) may be placed. In exemplary embodiments, the envelope portion also includes a lid, for example, a strip of material attached to an open end of the envelope portion. An inner surface of the lid may include adhesive thereupon. The lid may be folded downward so that the adhesive on its inner surface contacts a surface of the envelope portion to seal the envelope portion.

Similar to the envelope portion, the detachable component includes a pocket within which an item (e.g., a sheet of paper or other material) may be placed. In exemplary embodiments, the detachable component also includes a lid, for example, a strip of material attached to an open end of the detachable component. An inner surface of the lid may include adhesive thereupon. The lid may be folded downward so that the adhesive on its inner surface contacts a surface of the detachable component to seal the envelope portion.

In exemplary embodiments, the envelope includes a lid that is divided at a line of separation (e.g., a line of perforation) so that when the detachable component is separated from the envelope portion, the envelope's lid is also separated into a first lid attached to the envelope portion and a second lid attached to the detachable component. The first lid may be folded downward to seal the envelope portion. The second lid may be folded downward to seal the detachable component.

In exemplary embodiments of the envelope, the envelope includes a pocket that extends from a free end of the envelope portion to a free end of the detachable component. The pocket may be divided into a first pocket located within the envelope portion and a second pocket located within the detachable component. Glue or other adhesive may be applied to at least one inner surface of the envelope at a desired location to separate the envelope and its pocket into the envelope portion and the first pocket at one end of the envelope and the detachable component and the second pocket at the other end of the envelope. For example, the adhesive may be applied to an inner surface of a front face of the envelope, to an inner surface of a rear face of the envelope, or to the inner surfaces of both the front face and rear face of the envelope. The inner surfaces of the front and rear faces of the envelope are adhered together at the location where the adhesive was applied, thereby separating the envelope and its pocket into the envelope portion, detachable component, and their respective pockets. The location at which the inner surfaces of the front and rear faces of the envelope are adhered together is also the location of the line of separation at which the detachable component is separable from the envelope portion. In exemplary embodiments, the envelope portion is longer horizontally than the detachable component. In other embodiments, the detachable component may be longer horizontally than the envelope portion.

The detachable component is separable from the envelope portion at a line of separation, e.g., a line of perforation. In some embodiments, the envelope may include more than one line of separation. The line of separation may be located vertically on the envelope so that the envelope is bisected into two equal halves, or in other embodiments, the line of separation may be located vertically on the envelope either left of center or right of center. Once separated from the envelope portion, the detachable component constitutes a separate and distinct envelope having a pocket into which an item may be placed. The separated detachable component may also include its own lid as described above. After detachment from the envelope portion, the detachable component has an open top side and closed left, right, and bottom sides. In some embodiments, the side (left or right) of the detachable component at which it was separated from the envelope portion may also be an open side.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An envelope comprising an envelope portion and a detachable component that is separable from the envelope at a line of perforation.

2. The envelope of claim 1, wherein the detachable component comprises printed matter that comprises an offer for goods or services, a discount code, or a coupon.
